(19) United States
(12) Patent Application Publication
(10) Pub. No.: US 2010/0064978 A1
(43) Pub. Date: Mar. 18, 2010

(54) MULTI-PURPOSE LIVESTOCK SHELTER

(76) Inventors: ROBERT G. HOEFLING, Marcus, IA (US); ALAN J. HOEFLING, Marcus, IA (US); KENNETH J. HOEFLING, Kickapoo, IL (US); CHAD S. MAXWELL, Vermillion, SD (US)

Correspondence Address: MCKEE, VOORHEES & SEASE, P.L.C., 801 GRAND AVENUE, SUITE 3200, DES MOINES, IA, 50309-2721, US

(21) Appl. No.: 12/210,686

(22) Filed: Sep. 15, 2008

(51) Int. Cl. A01K 1/00

(52) U.S. Cl. 119/436

(57) ABSTRACT

A multi-use hoop building structure which can be built of varying materials; it has a hoop rafter structure and a flexible fabric coating, and has multi-side wall options for configuration in a variety of different ways, i.e., curtains, solid sides, solid sides with window and/or door combinations, and combination sides using some or all of the above options.

### FIELD OF THE INVENTION

This invention relates to a multi-purpose livestock shelter, suitable for housing and feeding a variety of different domestic livestock animals, including cattle, sheep, hogs and even poultry. Its suitability for various livestock and the ability to also adjust for various other specialized uses is a fundamental part of its advantage.

### BACKGROUND OF THE INVENTION

Barns and conventional livestock shelters to be effective must serve a variety of uses. They may, for example, be used for dairy barns. They may be used for hog farrowing systems. They may be used for storing hay or similar feed. They may be used for cattle feeding. Such multi-uses require different configurations for the barn. It is a general objective of the present invention to build a lightweight, cost efficient livestock building that may be used for farrowing, breeding, feeding, gestation, storage and other multi-purpose uses. The building can be configured to take advantage of environmental conditions such as southern sun exposure, cross-wind ventilation, moisture control, and shelter from sun, wind and rain during various seasons.

As can be seen from the above generalized description, it would be advantageous to have a single livestock housing or shelter which is inexpensive, capable of multiple uses, and which can take advantage of prevailing seasonal weather conditions, all with the idea in mind to assist the farmer in farming efficiency in any and all possible ways. This invention has as a primary objective providing this advantage.

The above advantage and objective is met by using a version of a hoop barn. As a general concept, hoop barns are known. See, for example, our commonly owned previous U.S. Pat. Nos. 7,165,508, 7,165,509, and 7,185,609, all of which relate to specialized hog farrowing systems, and do disclose a generic hoop building. However, the generic hoop building there shown (see FIG. 1 of U.S. Pat. No. 7,165,508) is shown without any detail and is shown as simply an optional shelter to build for housing a farrowing system within. In contrast, the hoop building of the present invention is specifically designed for multi-use maximum option availability for the farmer. It can also be used for greenhouse, warehouse, factory use, emergency housing, grain storage and even construction site storage or offices.

Another problem that this building solves is providing a cost efficient structure that provides adequate space requirements for animals if they are not free ranging in pastures, but are instead enclosed in a building structure. This is important in confined livestock areas where animals are not free ranging but mostly confined and therefore subject to herd diseases which can rapidly spread particularly if moisture, heat, and cold are not adequately compensated for in an adequately ventilated or closed (as the season of the year calls for) building shelter.

Other features and structural advantages of the shelter include methods and means for housing of animals, conditioning of hay, storage of hay, self-feeding of animals, providing maximum ventilation, providing various floors from dirt to cement to combinations of both, all at a minimum of expense. These and other advantages will be more apparent from the following description of the invention, to be read together with the accompanying drawings.

### BRIEF SUMMARY OF THE INVENTION

A multi-use hoop building structure which can be built of varying materials, has a hoop rafter structure and a flexible fabric coating over it with multi-side wall options for configuration in a variety of different ways, i.e., curtains, solid sides, solid sides with window and/or door combinations, and combination sides using some or all of the above side wall options.

### BRIEF DESCRIPTION OF THE DRAWINGS

FIG. 1 illustrates a perspective view of one form of hoop building structure of the present invention.

FIG. 2 shows the structure of FIG. 1 without the flexible roof covering so that the hoop framework can be seen.

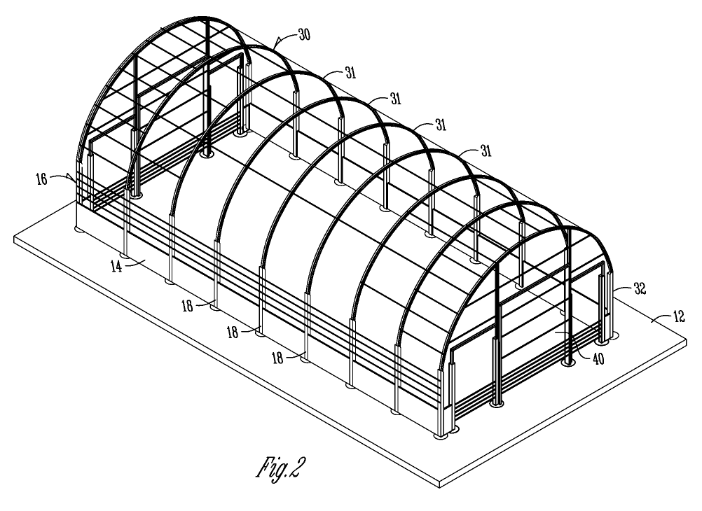

FIG. 3 shows a configuration of I-beam posts with channels which may be used to insert or remove modular wall boards.

### DETAILED DESCRIPTION OF THE PREFERRED EMBODIMENT

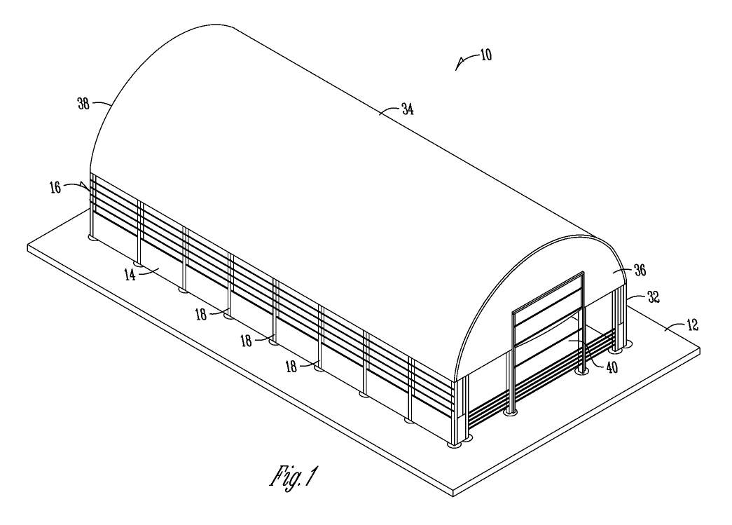

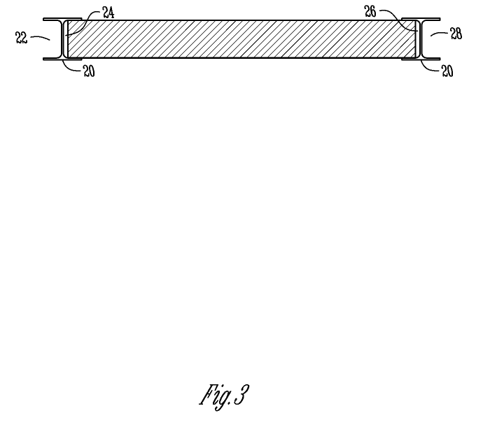

Referring now more particularly to drawings by character reference, FIG. 1 discloses the animal in storage shelter 10 as a perspective view. For purposes of description I refer to the long side of the shelter 10 as the south facing side 14. The shelter 10 is positioned on the ground 12 with a perimeter frame or foundation frame referred to generally as 16 extending upwardly from the foundation or ground 12. The foundation frame 16 is comprised of a series of spaced apart posts 18 which may, for example, be 5-6 feet apart and may be wooden posts, or as illustrated in FIG. 3, I-beam posts 20 defining channels 22, 24, 26 and 28. Posts 20 may be made of a variety of construction materials and can include wooden posts, steel posts, concrete posts, etc. Attached to post 20 and extending upwardly from the foundation frame 16 and over the foundation 12 is an awning hoop frame 30. Hoop frame 30 is formed of a network of steel hoops 31 extending from the north side 32 to the south side 14.

Flexible coated fabric 34 is pulled tight over the hoop frame 30 to define a flexible fabric cover. The flexible fabric cover can be made of non-metal natural materials, such as canvass or flexible polymer plastics like polyvinyl chloride, polyester, coated or uncoated, with one particularly useful material being fabric weaved material known as interwoven tape.

The building 10 can be varied in length and width to suit the specific application need. The height of the building is determined by two factors. First the width of the building and second the side wall height. Both of these can be varied to suit various applications.

The side walls, including both the north and the south facing side walls, and the opposing end walls 36 and 38 can be entirely of wood construction, or partially of the same coated fabric as the roof; that is they may have curtain sides to allow maximum ventilation flexibility, or may be solid sides to allow for maximum security; they may be side walls that have windows or doors 40, or they can use a combination of these features. The side walls can be configured using mobile panels in channel rails as shown in FIG. 3, which can simply be inserted and removed to provide removable panels to form various side wall configurations.

The hoop building can be easily expanded by adding more hoops and more cover, can be erected quickly to provide shelters in emergency situations like natural disasters, and can be used for agricultural uses including livestock housing, or grain or commodity storage, or equipment storage, and with the proper roof covering can even be a greenhouse. It can also be used for warehousing, for example, seed or agriculture equipment, or any other material in need of storage.

Floor configuration can be conveniently altered for any of the possible multi-purpose uses. A central chimney opening may be provided for air draft control.

It can therefore be seen that the invention accomplishes at least all of its stated objectives.

What is claimed is:

1. An animal and storage shelter, comprising:
a building foundation;
a foundation frame extending upwardly from the foundation to define frame sides;
an awning hoop frame extending upwardly from the foundation frame and over said foundation;
a flexible fabric-like covering at least partially covering the hoop frame to define a shelter roof;
said frame sides proving means for supporting multiple side wall options.

2. The shelter of claim 1 wherein the fabric like covering is selected from the group consisting of natural materials including canvass and cotton, synthetic materials including polymeric polyvinylchloride, polyethylene, coated or uncoated, and interwoven tape.

3. The shelter of claim 1 which uses wooden foundation frame posts.

4. The shelter of claim 1 which uses channel beam foundation posts.

5. The shelter of claim 4 which has frame sides formed of removable modular panels.

6. The shelter of claim 5 wherein the panels having multi-use options selected from windows, doors, solid panels, partial panels and partial flexible covering.
